(19) United States
(12) Patent Application Publication
(10) Pub. No.: US 2017/0051763 A1
(43) Pub. Date: Feb. 23, 2017

(54) Accumulator Driven Accessories

(71) Applicant: Caterpillar Global Mining Equipment LLC, Denison, TX (US)

(72) Inventors: Saeid Mirzaei, Muskego, WI (US); Suresh V. Venna, Menomonee Falls, WI (US); Anshu Srivastava, Shorewood, WI (US)

(73) Assignee: Caterpillar Global Mining Equipment LLC, Denison, TX (US)

(21) Appl. No.: 14/830,208

(22) Filed: Aug. 19, 2015

(51) Int. Cl. F15B 1/027; F15B 11/08; F15B 1/04

(52) U.S. Cl. CPC F15B 1/027; F15B 1/04; F15B 11/08; F15B 2201/50

(57) ABSTRACT

A hydraulic circuit is pressurized by a hydraulic pump driven by a power source in a machine. The hydraulic circuit is configured to use pressurized fluid from an accumulator to drive a hydraulic accessory when the hydraulic pump is inactive and the power source is shut down for fuel savings during idle operations. A valve may be configured to selectively supply pressurized hydraulic fluid to the accessory when the pump is inactive.

### TECHNICAL FIELD

The present disclosure is generally directed to a machine and, more particularly, to operation of a hydraulic accessory in the machine.

### BACKGROUND

Large machines, such as, but not limited to hauling or dump trucks used in mining operations, are mechanically complex and may be costly to operate. Such a machine often is exposed to high shock and vibration which may also reduce the serviceable lifetime of various parts. One such part is an air conditioning compressor that is mechanically coupled to an internal combustion engine and driven by gears off a flywheel or related engine part. As a result of this mechanical attachment, the air conditioning compressor may be subjected to higher than desirable vibration originating in the engine, which in turn may reduce the service life of the air conditioning compressor.

Further, in order to reduce fuel consumption and its associated cost, newer machines are automatically reducing engine power or even turning the engine completely off when the machine is not traveling. For example, the engine may be shut off while waiting to load or unload, during loading, idling, or other downtime. While this can result in significant savings, for example, of as much as 450 gallons of fuel per year per machine, a side effect is that certain accessories, including the air conditioner, are not available during these periods. Depending on the environment and season, this may cause an operator unwelcomed discomfort.

With respect to machine air conditioning compressors, U.S. Pat. No. 8,909,431, issued Dec. 9, 2013 to Kooi (the '431 patent), discloses calculating a load on an internal combustion engine including the load demand from an air conditioning compressor and adjusting a power output of the engine accordingly. However, among other things, the '431 patent fails to address providing cooling during intermittent periods when the engine is shut down.

### SUMMARY OF THE DISCLOSURE

In an aspect of the disclosure, a machine includes a power source, a hydraulic pump powered by the power source that provides pressurized hydraulic fluid and an accumulator that stores the pressurized hydraulic fluid provided by the hydraulic pump. The machine also includes an accessory operated via the pressurized hydraulic fluid and a valve that selectively provides the pressurized hydraulic fluid from the accumulator to the accessory to operate the accessory when the hydraulic pump is inactive.

In another aspect of the disclosure, a method of operating a compressor in a machine includes powering a hydraulic pump using a power source of the machine, the hydraulic pump providing a pressurized hydraulic fluid in a hydraulic circuit and charging an accumulator with the pressurized hydraulic fluid. The method may include sensing that the hydraulic pump is inactive and providing the pressurized hydraulic fluid from the accumulator to an accessory when the hydraulic pump is inactive. The method may conclude by operating the accessory while the hydraulic pump is inactive using the pressurized hydraulic fluid from the accumulator.

In still another aspect of the disclosure, a machine having a power source and a hydraulic pump driven by the power source may include an accumulator that stores a pressurized hydraulic fluid provided by the hydraulic pump and an air conditioning compressor operated via the pressurized hydraulic fluid. The machine may also include a valve that directs the pressurized hydraulic fluid from the accumulator to the air conditioning compressor only when the hydraulic pump is inactive.

These and other aspects and features will be more readily understood when reading the following detailed description when taken in conjunction with the accompanying drawings.

### BRIEF DESCRIPTION OF THE DRAWINGS

FIG. 1 is a perspective view of a machine in accordance with the current disclosure;

FIG. 2 is a block diagram of an embodiment of a system for accumulator driven accessories;

FIG. 3 is a block diagram of another embodiment of a system for accumulator driven accessories; and

FIG. 4 is a flowchart illustrating an exemplary method of operating an accessory in a machine using an accumulator.

### DETAILED DESCRIPTION

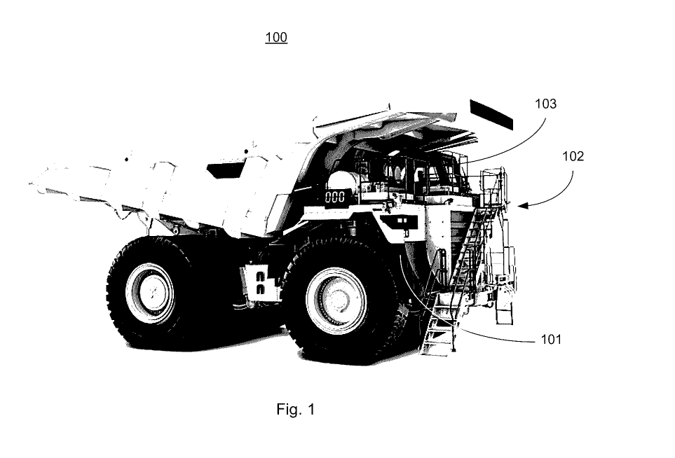

Referring to FIG. 1, a machine 100 is illustrated. The particular machine 100 shown is a haul truck may be particularly useful in mining industry, but the techniques described below are applicable to any number of machines and vehicles used in other fields such as, but not limited to, earthmoving, construction, agriculture, transportation, forestry, and marine industries. The machine 100 may use a power source 101, such as an internal combustion engine, to provide primary power to the machine 100. The power source 101 may provide power to a drivetrain of the machine 100 as well as being a principal source of power for operating electrical and hydraulic equipment and accessories. The machine 100 may include an operator station 103 used by a human operator to control the machine 100.

As discussed more below, the machine 100 may incorporate a system 102 for operating a hydraulically-driven accessory while the power source 101 of the machine 100 is turned off or operating at an idle speed that is too low to sufficiently power the accessory.

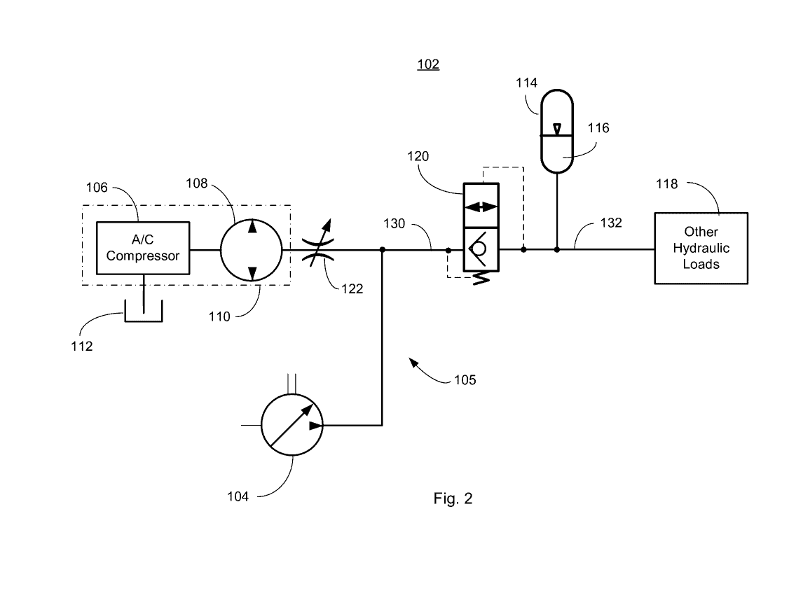

A system 102 for operating an accessory 110 that is hydraulically driven is illustrated in FIG. 2. The system 102 may include a pump 104 that supplies pressurized hydraulic fluid 116 to a hydraulic circuit 105 including the accessory 110. Low pressure fluid may be returned to a tank 112. In an embodiment, the accessory 110 may be an air conditioning unit that includes a hydraulic motor 108 that drives an air conditioning compressor 106. In another embodiment, the accessory may only include the hydraulic motor 108 and a standalone air conditioning compressor 106 or other mechanical accessory (not depicted) may be included. The hydraulic circuit 105 may also include other hydraulic loads 118, such as, but not limited to, hydraulic cylinders that drive or move work tools (not depicted). An accumulator 114 may be used to store pressurized hydraulic fluid 116. As used herein “accessory” may include any number of machine components drawing power via a hydraulic source such as, but not limited to, air conditioners, heaters, humidifiers, blowers, communication devices, operator controls, ladder cylinders, and the like.

When the machine is in normal operation, the accumulator 114 may act to even out pressure in the hydraulic circuit 105 by absorbing pressure spikes and may also act to provide pressurized hydraulic fluid during peak loads. In a some embodiments, multiple accumulators may be used in such a hydraulic circuit 105, even though only one accumulator 114 is illustrated in FIG. 2. In prior art applications, turning off the power source 101 for relatively short periods was not a consideration so that whenever the power source 101, and therefore the pump 104, was turned off, any accumulators were drained via a valve, so that high pressure hydraulic fluid did not remain and potentially cause wear on seals or have other undesired side effects.

However, as discussed above, in a current embodiment, the power source 101 may routinely be turned off for short periods during idle conditions to save fuel and to be more ecologically friendly. When this happens, some accessories, especially the air conditioning compressor 106 cease to operate. Depending on conditions, an operator's cab may become uncomfortably hot in a very short time with the air conditioning off Rather than simply draining the accumulator 114 during a short idle period, a valve 120 may be used to allow the pressurized hydraulic fluid 116 in the accumulator 114 to operate the accessory 110, in this example, the air conditioning compressor 106.

The valve 120 may be positioned as a check valve during normal operations, for example, to shield the pump 104 from pressure spikes generated by tools associated with the other hydraulic loads 118. When the pump 104 is off and the pressure at the accumulator side 132 of the valve 120 remains higher than the pressure on the pump side 130 of the valve 120, pilot pressure on the accumulator side 132 of the valve 120 opens the valve 120 and allows free flow of pressurized hydraulic fluid 116 from the accumulator 114 to the accessory 110.

When the pump 104 is off, especially when due to the power source 101 being shut down, the other hydraulic loads 118 are not active. That is, if the machine 100 is idle, such as waiting to be loaded, there is no reason to activate the hydraulic cylinders to lift a bed of the machine 100. Therefore, pressurized hydraulic fluid 116 in the accumulator 114 that would typically be drained can be used to operate the accessory 110 and provide air conditioning to the operator station 103. Note the air conditioning fan is electric and can be operated during these short idle periods by the machine battery.

An orifice 122 may be inserted to limit flow to the accessory 110, or in the case of an adjustable orifice, to adjust the flow to the accessory 110. For example, the orifice 122 may be adjusted based on an output requirement of the air conditioning compressor 106 and a pressure of the pressurized hydraulic fluid 116 at the accumulator 114. In an embodiment, the orifice 122 may be opened further as the pressure from the accumulator 114 drops.

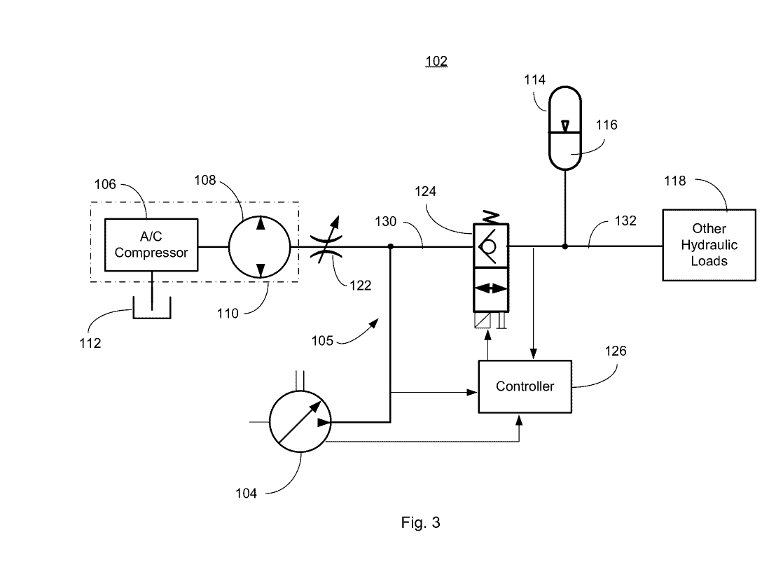

FIG. 3 illustrates an alternate embodiment of the system 102 using an electrohydraulic valve 124 instead of the hydraulically operated valve 120 of FIG. 2. In this embodiment, a controller 126 may monitor pressure values on both sides 130, 132 of the electrohydraulic valve 124 as well as conditions at the pump 104. The controller 126 may use these inputs, or others, to determine when the electrohydraulic valve 124 should be positioned to allow the accumulator 114 to power the accessory 110. The controller 126 may then provide a signal that causes the valve 124 to change positions.

The controller 126 may also directly monitor the pump 104 and/or the power source 101 to make the determination that the pump 104 is inactive and to operate the valve 124.

### INDUSTRIAL APPLICABILITY

In general, the present disclosure can find industrial applicability in machines in a number of different settings, such as, but not limited to those use in the earth-moving, construction, mining, agriculture, transportation, forestry, and marine industries.

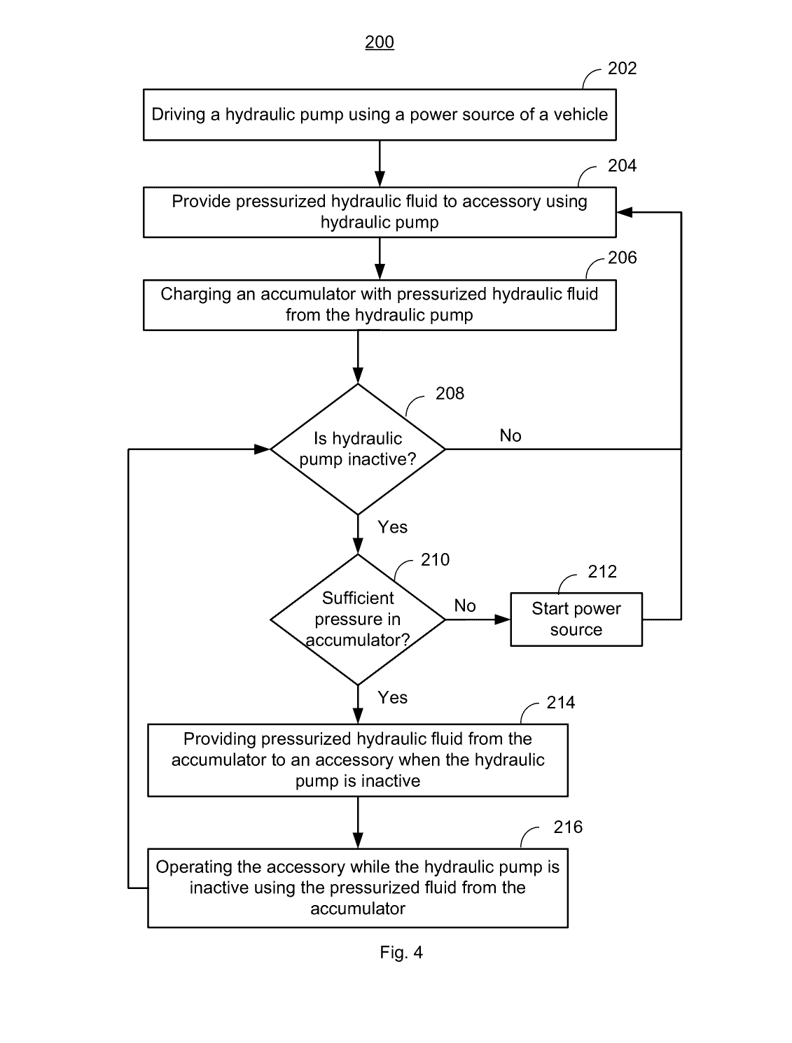

A flowchart of a method 200 of operating an accessory 110 when a power source 101 of a machine 100 is turned off is shown in FIG. 4. At block 202, a hydraulic pump 104 may be driven using the power source 101 of the machine 100. In an embodiment, the power source 101 may be an internal combustion engine using diesel, gasoline, LNG, or other gaseous hydrocarbon fuels. The hydraulic pump 104 may provide pressurized hydraulic fluid 116 in a hydraulic circuit 105.

At block 204, pressurized hydraulic fluid may be provided to an accessory 110. As discussed above, the accessory 110 may be any number of devices driven directly or indirectly by pressurized hydraulic fluid.

An accumulator 114 may be charged with the pressurized hydraulic fluid 116 delivered by the hydraulic pump 104 via the hydraulic circuit 105 at block 206. The accumulator 114 may be used to provide a buffer for sudden pressure increases or decreases in the hydraulic circuit 105.

An operating state of the hydraulic pump may be sensed at block 208. Specifically, conditions at the pump 104, the power source 101, or in the hydraulic circuit 105 may be sensed to determine that the pump 104 is inactive. This determination may be made in a number of manners. In an embodiment, a hydraulic pressure at both sides of the valve 120 may compared simply by how a bias of the valve 120 is selected, as shown in the embodiment of FIG. 2. In such an embodiment, the valve 120 will remain in the illustrated position until a reduction in pump 104 output causes a pressure drop on the pump side 130 of the valve 120 and the higher pressure on the accumulator side 132 causes the valve 120 to change to the opposite, or free-flowing position.

In another embodiment, illustrated, for example, in FIG. 3, a controller 126 may sense the pressure on both sides of the valve 124. The controller 126 can determine that the pump is inactive by comparing a measured pressure of each side of the valve. When the pressure on the pump side of the valve 124 is lower that a pressure on the accumulator side of the valve 124 for more than a brief period, the controller 126 can determine that the pump 104 is inactive. The controller 126 may then send a signal that causes the valve 124 to switch to the free-flowing position. In another embodiment, the controller 126 may directly sense that the pump 104 is inactive using, for example, using a pressure sensor to determine when a output pressure of the pump is below a threshold pressure or by using a speed sensor to monitor if the pump 104 is turning. Other ways to sense that the pump 104 is inactive may also be used. For example, the controller 126 may receive a signal indicating the power source 101 is off since the power source 101 exclusively drives the pump 104.

If it is determined at block 208 that the pump 104 is active, the “no” branch may be taken to block 204 and the loop continued. If, however, it is determined at block 208 that the pump 104 is inactive, the “yes” branch may be taken from block 208 to block 210. At block 210, a further check may be made to determine if the pressure in the accumulator 114 is above a minimum pressure or if the pressure difference across the valve 120, 124 is above a threshold value. In various embodiments, this may involve a direct measurement or may be part of the process that determines that the pump 104 is inactive. For example, in the embodiment illustrated in FIG. 2, the hydraulically operated valve will only open when the pressure in the accumulator 114 is sufficiently above the pump-side 130 pressure. In this embodiment, a bias in the valve 120 can be set assuming little or no pressure on the pump-side 130 so that the valve 120 only opens when there is sufficient pressure in the accumulator 114 to drive the accessory 110.

When, at block 210, the pressure is insufficient, the “no” branch may be taken to block 212 and the power source 101 may be restarted with execution then continuing at block 204.

When, at block 210, the pressure in the accumulator 114 is sufficient, the “yes” branch may be taken to block 214 and pressurized hydraulic fluid 116 from the accumulator 114 may be provided to an accessory 110. In an embodiment, activating the valve 120 or 124 may fluidly connect the accumulator 114 to the accessory 110 only when the hydraulic pump 104 is inactive or the pressure at the accumulator 114 is sufficient. In an embodiment, the accessory 110 may be a hydraulic motor 108 that drives an air conditioning compressor 106. In another embodiment, the accessory 110 may be an integrated air conditioning unit having both the hydraulic motor 108 and the air conditioning compressor 106 as a single unit.

Finally, the accessory 110 may be operated at block 216 using the pressurized hydraulic fluid 116 from the accumulator 114 when the hydraulic pump 104 is inactive. In the case where the accessory 110 is an air-conditioning unit, operating the accessory is associated with providing air conditioning to an operator station 103 of the machine 100. Operation at block 212 may continue as long as the pump is inactive or until the accumulator 114 can no longer supply sufficient pressurized hydraulic fluid 116 to operate the accessory.

The ability to use the pressurized fluid from the accumulator 114 to drive an accessory 110, especially an air conditioning compressor 106, when a power source 101 and therefore a hydraulic pump 104 of a machine 100 is off, provides a benefit not only to operators but to owners as well. The immediate benefit to an operator is not having to sit in a hot cab during idle periods. The benefit to an owner is that a more aggressive energy saving policy can be implemented by turning the power source 101 off more frequently under a broader range of conditions without unduly burdening the operator.

The use of a hydraulically-driven compressor 106 over prior art mechanical air conditioning compressors that are gear driven by the power source 101 benefits the owner by reduced downtime and increased service life by moving the accessory 110 away from the high shock and vibration of the power source 101. Further, an operating speed of the accessory 110 can be independently controlled by the flow of pressurized hydraulic fluid 116, where the speed of the prior art mechanical compressor was solely tied to the speed of the power source.

While the above discussion has been directed to a particular type of machine, the techniques described above have application to many other machines.

What is claimed is:

1. A machine comprising:
a power source;
a hydraulic pump that provides pressurized hydraulic fluid, the hydraulic pump powered by the power source;
an accumulator that stores the pressurized hydraulic fluid provided by the hydraulic pump;
an accessory operated via the pressurized hydraulic fluid; and
a valve that selectively provides the pressurized hydraulic fluid from the accumulator to operate the accessory when the hydraulic pump is inactive.

2. The machine of claim 1, wherein the accessory is an air conditioning compressor.

3. The machine of claim 1, wherein the accessory is driven by a hydraulic motor coupled to the accumulator via the valve.

4. The machine of claim 3, further comprising an orifice that restricts flow from the accumulator to the hydraulic motor when the hydraulic pump is inactive and when the pressurized hydraulic fluid in the accumulator is above a minimum pressure.

5. The machine of claim 4, wherein the orifice is an adjustable orifice that selectively restricts the flow from the accumulator to the hydraulic motor when the hydraulic pump is inactive and when the pressurized hydraulic fluid in the accumulator is above the minimum pressure.

6. The machine of claim 3, wherein the hydraulic pump provides the pressurized hydraulic fluid directly to the hydraulic motor when the hydraulic pump is active.

7. The machine of claim 1, wherein the valve is an electrohydraulic valve.

8. The machine of claim 1, wherein the valve is a hydraulic pressure activated valve.

9. A method of operating a compressor in a machine, the method comprising:
powering a hydraulic pump using a power source of the machine, the hydraulic pump providing a pressurized hydraulic fluid in a hydraulic circuit;
charging an accumulator with the pressurized hydraulic fluid;
sensing that the hydraulic pump is inactive;
providing the pressurized hydraulic fluid from the accumulator to an accessory when the hydraulic pump is inactive; and
operating the accessory while the hydraulic pump is inactive using the pressurized hydraulic fluid from the accumulator.

10. The method of claim 9, wherein providing the pressurized hydraulic fluid from the accumulator to the accessory when the hydraulic pump is inactive comprises activating a valve that permits fluid flow from the accumulator to the accessory only when the hydraulic pump is inactive.

11. The method of claim 10, wherein activating the valve comprises configuring the valve to self-actuate responsive to a first pressure at an accumulator side of the valve being higher than a second pressure at a hydraulic pump side of the valve.

12. The method of claim 10, wherein activating the valve comprises configuring the valve to activate responsive to a signal from a controller that senses at least one of that the hydraulic pump is inactive or that the pressurized hydraulic fluid in the accumulator is above a minimum pressure.

13. The method of claim 10, wherein sensing that the hydraulic pump is inactive comprises determining that the power source of the machine is off.

14. The method of claim 13, further comprising:
determining that the pressurized hydraulic fluid in the accumulator is below a minimum pressure;
restarting the power source; and
providing additional pressurized hydraulic fluid from the hydraulic pump to the accessory via the hydraulic circuit.

15. A machine having a power source and a hydraulic pump driven by the power source, the machine comprising:
an accumulator that stores a pressurized hydraulic fluid provided by the hydraulic pump;
an air conditioning compressor operated via the pressurized hydraulic fluid; and
a valve that direct the pressurized hydraulic fluid from the accumulator to the air conditioning compressor only when the hydraulic pump is inactive.

16. The machine of claim 15, wherein the valve is an electrohydraulic valve, the machine further comprising a controller that causes the valve to direct the pressurized hydraulic fluid from the accumulator to the air conditioning compressor responsive to the controller determining that the hydraulic pump is inactive and when the pressurized hydraulic fluid in the accumulator is above a minimum pressure.

17. The machine of claim 15, wherein the valve is a hydraulic pressure activated valve that couples the accumulator to the air conditioning compressor when an output pressure of the hydraulic pump is less than a threshold pressure.

18. The machine of claim 17, wherein the threshold pressure is determined by comparing a first pressure at one side of the valve to a second pressure at a second side of the valve.

19. The machine of claim 15, further comprising an orifice that limits flow of the pressurized hydraulic fluid from the accumulator to the air conditioning compressor when the valve is directing the pressurized hydraulic fluid from accumulator to the air conditioning compressor.

20. The machine of claim 19, wherein the orifice in an adjustable orifice that changes the flow of the pressurized hydraulic fluid from the accumulator to the air conditioning compressor based on one of an output requirement for the air conditioning compressor and a pressure of the pressurized hydraulic fluid at the accumulator.
